(19) United States
(12) Patent Application Publication
(10) Pub. No.: US 2013/0172454 A1
(43) Pub. Date: Jul. 4, 2013

(54) FIRE-RETARDANT THERMOPLASTIC POLYURETHANE RESIN COMPOSITION FOR TELECOMMUNICATION CABLE COVERING

(71) Applicants: Chan-Yong SEONG, Gyeonggi-do (KR); Dong-Hun Kim, Incheon Metropolitan City (KR); Kyoung-Jin Kim, Gyeonggi-do (KR); Young-Shik Kim, Gyeonggi-do (KR); Hwan-Chul Bae, Seoul (KR); You-Jin Nam, Incheon Metropolitan City (KR)

(72) Inventors: Chan-Yong SEONG, Gyeonggi-do (KR); Dong-Hun Kim, Incheon Metropolitan City (KR); Kyoung-Jin Kim, Gyeonggi-do (KR); Young-Shik Kim, Gyeonggi-do (KR); Hwan-Chul Bae, Seoul (KR); You-Jin Nam, Incheon Metropolitan City (KR)

(73) Assignee: TSC CO., LTD., Gyeonggi-do (KR)

(21) Appl. No.: 13/484,545

(22) Filed: May 31, 2012

(30) Foreign Application Priority Data
Dec. 29, 2011 (KR) 10-2011-0145821

(51) Int. Cl. C09D 175/04; C08K 5/3492

(52) U.S. Cl. 524/101

(57) ABSTRACT

Disclosed is a halogen-free fire-retardant polyolefin resin composition for a telecommunication cable covering, which includes 50˜74 wt % of thermoplastic polyurethane, 1˜10 wt % of maleic anhydride grafted styrene-ethylene/butylene-styrene, 5˜38 wt % of melamine cyanurate and 2˜20 wt % of an organic phosphinate salt, and in which fire retardancy is maintained, whitening or bleeding is prevented and scratch hardness is high, despite the use of a small amount of fire retardant.

### BACKGROUND OF THE INVENTION

1. Field of the Invention

The present invention relates to a fire-retardant thermoplastic polyurethane resin composition for a telecommunication cable covering. The composition of the present invention is employed in a cable for charging a battery or in covering an electrical cord of an appliance.

2. Description of the Related Art

Typically, cables for use in electrical and electronic devices are provided in the form of a wire covered with an insulation material to achieve electrical insulation and prevent the outbreak of a fire. Widely useful as such an insulation material is a synthetic resin composition.

A conventional synthetic resin composition for a wire covering typically includes a PVC-based resin composition, and a polyolefin-based resin composition such as polyethylene, etc., is broadly used as a replacement of the PVC-based resin composition.

The PVC-based resin composition is advantageous because of low price, high processability and high fire retardancy and of facilitating coloration of products, but is environmentally unfriendly.

PVC resins require the use of a variety of additives such as a plasticizer, a stabilizer, etc. upon preparation into a composition. Furthermore, PVC resins themselves contain a halogen component undesirably generating harmful gases upon burning, and also they may emit environmentally regulated materials such as heavy metals, environmental hormones, etc. due to the use of the variety of additives, and thus the number of countries which limit the use thereof has gradually, increased. Hence, the use of a halogen-free insulation material which does not generate any harmful gas is recommended these days and the quality level for a “halogen-free fire-retardant polyolefin power cable” is prescribed in Korea Standard KSC 3341.

The base resin of the halogen-free insulation material comprises light resins (light-molecular weight resin), such as polyolefin or polyurethane resins containing no halogen component in the molecule thereof. A resin composition comprising a light resin as the base resin is advantageous in terms of superior processability and insulating properties even without the addition of a plasticizer, a stabilizer, etc., while preventing the generation of harmful gases such as halogens upon burning, but has a low softening temperature, in the case of low-density polyethylene (LDPE), its shape cannot be maintained even in the presence of heat of about 130° C. In order to increase the softening temperature and impart fire retardancy, a large amount of inorganic fire retardant is used. In the case of an LOPE resin composition, an inorganic fire retardant such as Mg(OH)₂ is used in an amount of at least 50 wt % based on the weight of the composition.

When the inorganic fire retardant is used in a large amount of 50 wt % or more to impart fire retardancy and increase the softening temperature, fire retardancy and softening properties may be improved, but the covered wire may suffer from whitening (when the covered wire is bent and then unbent, white spots appears on the surface thereof) and bleeding, and scratch resistance and tensile strength may deteriorate, undesirably lowering the quality.

Upon bleeding in which the soluble component of the composition may dissolve and transfer to the surface, the soluble component dissolved on the surface may be colored, undesirably lowering the quality.

Thus, there is a need to develop a synthetic resin composition for a cable covering which is advantageous in terms of superior electrical insulating properties, heat resistance and fire retardancy and high scratch hardness without whitening or bleeding.

### SUMMARY OF THE INVENTION

Accordingly, the present invention has been made keeping in mind the above problems encountered in the related art, and an object of the present invention is to provide a resin composition for a telecommunication cable covering, which may prevent whitening or bleeding and is environmentally friendly while maintaining fire retardancy, scratch resistance and tensile strength of a conventional PVC-based resin composition.

The resin composition of the present invention exhibits fire-retardant properties corresponding to UL1581VW-1.

The resin composition of the present invention is a fire-retardant resin composition for a cable covering comprising thermoplastic polyurethane (TPU) as a base resin, maleic anhydride grafted styrene-ethylene/butylene-styrene (hereinafter referred to as SEES-g-MAH) as a compatibilizer, and an organic phosphinate salt and melamine cyanurate as a fire retardant.

In the production of the halogen-free fire-retardant synthetic resin composition for a telecommunication cable covering, when the thermoplastic polyurethane resin as the base resin, SEBS-g-MAH as the compatibilizer and the organic phosphinate salt and melamine cyanurate as the fire retardant are used electrical insulating properties, heat resistance and processability become superior, and harmful gases are not generated upon burning, and scratch hardness is high, and whitening does not occur, despite the use of a decreased amount of fire retardant.

The present inventors have paid attention to the fact that whitening or bleeding in a light resin composition including a large amount of inorganic fire retardant is based on insufficient bondability between the resin matrix and the fire retardant, and thus have ascertained that when preparing a fire-retardant TPU resin composition comprising SEBS-g-MAH having high bondability with a fire retardant and high compatibility with TPU as a compatibilizer and an organic phosphinate salt having high bondability with SEBS-g-MAH as a fire retardant, whitening or bleeding may be prevented despite the use of a comparatively small amount of fire retardant, resulting in the present invention.

### DESCRIPTION OF SPECIFIC EMBODIMENTS

The present invention will be described in detail via the following examples.

### Example 1

5 kg of TPU, 1 kg of SEBS-g-MAH, 3.5 kg of melamine cyanurate, and 0.5 kg of an organic phosphinate salt were placed in a kneader, uniformly mixed at 120˜140° C., and melt extruded at 145˜160° C. using an extruder, thus obtaining 10 kg of a resin composition.

As such, the use of TPU having a molecular weight of about 20,000˜700,000 is preferable.

In the field of a resin composition for a wire covering, a resin having a molecular weight of 20,000˜700,000 is typically used.

If the molecular weight is too high or low, flexibility, processability and wear resistance may become problematic.

SEBS-g-MAH, which is used together with TPU, exhibits elastic properties at room temperature without vulcanization. If the amount of this component exceeds 10 wt % in the resin composition, wear resistance and scratch resistance may decrease.

To increase compatibility with TPU, the amount of styrene is appropriately set to about 30˜60 wt %.

Because SEBS-g-MAH (maleic anhydride grafted SEBS) functions to increase the bonding between the resin matrix and the fire retardant, whitening or bleeding is considered to be suppressed by minimizing the breakage of resin bonding under external stress.

As the fire retardant, a combination of a nitrogen-based fire retardant, for example, melamine cyanurate, and a phosphorus-based fire retardant, for example, an organic phosphinate salt was used.

Even when the combination of melamine cyanurate and organic phosphinate salt is used as the fire retardant, the amount of the fire retardant is maintained to 40 wt % or less based on the total weight of the resin composition so that fire retardancy and softening properties can be ensured.

Melamine cyanurate which is the nitrogen-based fire retardant decomposes into melamine and cyanuric acid when heat is applied thereto thus absorbing a large amount of heat and emitting nitrogen gas, thereby imparting fire retardancy. Also, the organic phosphinate salt which is the phosphorus-based fire retardant produces phosphoric acid upon thermal decomposition, thus imparting fire retardancy due to the phosphoric acid layer. The use of the combination of two kinds of fire retardants can be seen to exhibit superior fire retardancy.

### Examples 2˜4

Resin compositions were obtained in the same manner as in Example 1 using the components in the amounts shown in Table 1 below. In Examples 2˜4, the resin compositions were prepared in the same manner as in Example 1 with the exception that the components were used in different amounts.

### Comparative Examples 1˜2

Resin compositions were obtained in the same manner as in Example 1 using the components in the amounts shown in Table 1 below.

In Comparative Examples 1˜2, the resin compositions were prepared in the same manner as in Example 1 with the exception that the components were used in different amounts.

The compositions of Comparative Examples 1˜2 are typical compositions in the corresponding field.

TABLE 1
Component and Amount of Resin Composition (unit: kg)

| | C. Ex. | | Ex. | | | |
|---|---|---|---|---|---|---|
| | 1 | 2 | 1 | 2 | 3 | 4 |
| EVA | 1 | | | | | |
| LDPE | 1 | | | | | |
| TPU | | 2.5 | 5 | 7.4 | 6.5 | 5.6 |
| SEBS | | | | | | |
| PP | | | | | | |
| Paraffin oil (softener) | | | | | | |
| SEBS-g-MAH | | | 1 | 0.1 | 0.5 | 0.4 |
| (compatibilizer) | | | | | | |
| EVA-g-MAH (compatibilizer) | 1 | 0.5 | | | | |
| Melamine Cyanurate | | | 3.5 | 0.5 | 2.0 | 3.8 |
| (fire retardant) | | | | | | |
| Organic Phosphinate Salt | | | 0.2 | 2 | 1 | 0.2 |
| (fire retardant) | | | | | | |
| Magnesium Hydroxide | 7 | 7 | | | | |
| (fire retardant) | | | | | | |
| TOTAL (wt %) | 100 | 100 | 100 | 100 | 100 | 100 |

EVA: ethylene vinyl acetate
LDPE: low-density polyethylene (ENGAGE 8440, available from Dow Chemical)
TPU: TPU 6185AP, available from Dongsung Hichem
SEBS: styrene-ethylene/butylene-styrene (Septon 8007, available from Kuraray)
EVA-g-MAH: ethylene vinyl acetate-graft maleic anhydride
Organic phosphinate salt: Exolite OP-930, available from Clarient
PP: polypropylene (H-1500, available from GS Caltex)

The quality of the compositions of the present invention comprising TPU, SEBS-g-MAH, melamine cyanurate and organic phosphinate salt was evaluated. As a result, the composition comprising 50˜74 wt % of TPU, 1˜10 wt % of SEBS-g-MAR, 5˜38 wt % of melamine cyanurate, and 2˜20 wt % of organic phosphinate salt within the range of the sum of melamine cyanurate and organic phosphinate salt not, exceeding 40 wt % was suitable.

TABLE 2
Quality Evaluation Test Results

| | C. Ex. | | Ex. | | | |
|---|---|---|---|---|---|---|
| Test Items | 1 | 2 | 1 | 2 | 3 | 4 |
| Fire Retardancy | Good | Good | Good | Good | Good | Good |
| Tensile Strength (kgf/cm²) | 88 | 106 | 187 | 225 | 209 | 174 |
| Whitening | Yes | Yes | No | No | No | No |
| Bleeding | No | No | No | No | No | No |
| Wear Resistance (numbers) | 56 | 89 | 157 | 192 | 176 | 149 |

Evaluation Method

Fire retardancy: UL 1581. VW-1 flame test depending on whether flame generated on a test sample reaches a predetermined distance or more.

Tensile strength: ASTM D638 depending on the synthetic resin tensile strength measurement method.

Whitening: Whitening is observed with the naked eye when bending is applied to a test sample having a thickness of 1 mm under conditions of a curvature radius of 5 mm.

Bleeding: A test sample having a thickness of 1 mm, a width of 10 mm, and a length of 10 mm is allowed to stand in a constant temperature humidity chamber at 80° C. and a relative humidity of 80% for 15 days and then whether transfer thereof is generated is observed with the naked eye.

Wear resistance: A weight of 310 g is placed on a needle having a diameter of 0.125 mm on a test sample having a thickness of 1 mm, a width of 2 mm and a length of 100 mm and then a mutual movement is performed so that the test sample is scratched with the needle. After at least 100 mutual movements, the test sample should not be punctured.

As described hereinbefore, the present invention provides a fire-retardant thermoplastic polyurethane resin composition for a telecommunication cable covering. According to the present invention, the halogen-free fire-retardant resin composition is advantageous because fire retardancy can be maintained, whitening or bleeding can be prevented and high scratch hardness can be obtained, despite the use of a small amount of fire retardant.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A halogen-free fire-retardant polyolefin resin composition for a telecommunication cable covering comprising 50˜74 wt % of thermoplastic polyurethane, 1˜10 wt % of maleic anhydride grafted styrene-ethylene/butylene-styrene, 5˜38 wt % of melamine cyanurate and 2˜20 wt % of an organic phosphinate salt.
